(19) United States
(12) Patent Application Publication
(10) Pub. No.: US 2026/0334502 A1
(43) Pub. Date: Oct. 29, 2026

(54) SLUSH MACHINE CAPABLE OF COLLECTING CONDENSED WATER

(71) Applicant: Zhuhai Yingweituo Technology Co., Ltd., Zhuhai (CN)

(72) Inventor: Yisheng LI, Zhuhai (CN)

(73) Assignee: Zhuhai Yingweituo Technology Co., Ltd., Zhuhai (CN)

(21) Appl. No.: 19/337,782

(22) Filed: Sep. 23, 2025

(30) Foreign Application Priority Data
Apr. 29, 2025 (CN) 202520849380X

(51) Int. Cl. A23G 9/04; A23G 9/12; A23G 9/30

(52) U.S. Cl. CPC A23G 9/045; A23G 9/12; A23G 9/30

(57) ABSTRACT

A slush machine capable of collecting condensed water includes a machine body. The machine body is provided with a horizontally placed ice making assembly and a material container detachably sleeved over the ice making assembly, the machine body is provided with a water collecting plate below the material container, the machine body is detachably provided with a water tank below the water collecting plate, a water receiving port facing the water collecting plate is arranged at an upper end of the water tank, a water drainage port aligned with the water receiving port is arranged in the water collecting plate, and when the material container is separated from the ice making assembly, a height space capable of cleaning the water collecting plate is defined between the ice making assembly and the water collecting plate.

### CROSS-REFERENCE TO RELATED APPLICATION

This application is based on and claims the benefit of priority from Chinese Patent Application No. 202520849380X, filed on 29 Apr. 2025, the entirety of which is incorporated by reference herein.

### TECHNICAL FIELD

The present disclosure relates to the technical field of household appliances, and in particular, to a slush machine capable of collecting condensed water.

### BACKGROUND

At present, common slush machines are typically horizontal structures, that is, the ice making mechanism is placed horizontally. A material container for storing shaved ice is sleeved over the ice making mechanism, and a switch valve assembly is arranged on the material container for controlling discharge of the prepared shaved ice. Since the temperature of the shaved ice is relatively low, external air will form condensed water when being in contact with the outer wall of the material container. An existing slush machine is typically connected to a water pipe extending to a water receiving tray below the material container. The water pipe cannot be disassembled for cleaning. When the material container is removed, the shaved ice may easily fall into the water pipe and form foreign matter residue. Moreover, the water receiving tray is used for placing a shaved ice container and storing condensed water, resulting in an overly large water receiving tray that is neither aesthetically pleasing nor practical.

### SUMMARY

To overcome the deficiencies in the existing technologies, one of the objectives of the present disclosure is to provide a slush machine that is easy to clean collected condensed water or shaved ice, to avoid foreign matter residue, and a water pipe is not required to be connected to a water receiving tray to avoid increasing the volume of the water receiving tray.

In accordance with an embodiment of the present disclosure, a slush machine capable of collecting condensed water includes: a machine body, where the machine body is provided with a horizontally placed ice making assembly and a material container detachably sleeved over the ice making assembly, the machine body is provided with a water collecting plate below the material container, the machine body is detachably provided with a water tank below the water collecting plate, a water receiving port facing the water collecting plate is arranged at an upper end of the water tank, a water drainage port aligned with the water receiving port is arranged in the water collecting plate, and when the material container is separated from the ice making assembly, a height space capable of cleaning the water collecting plate is defined between the ice making assembly and the water collecting plate.

In accordance with the embodiment of the present disclosure, the slush machine capable of collecting condensed water has at least the following beneficial effects.

In the slush machine of the above structure, the water collecting plate is used to receive the condensed water dripping from the outer peripheral wall of the material container. The condensed water enters the water tank through the water drainage port and the water receiving port in turn. The condensed water can be poured out by removing the water tank from the machine body. When the shaved ice remains on the water collecting plate due to removing the material container, the cleaning can also be achieved even if the shaved ice solution enters the water tank. The height space between the ice making assembly and the water collecting plate can enable users to clean the shaved ice remaining on the water collecting plate. In the above slush machine, it is unnecessary to connect the water receiving tray with a water pipe. This avoids increasing the volume of the water receiving tray, and facilitates cleaning of the collected condensed water or shaved ice to avoid foreign matter residue.

In some embodiments of the present disclosure, a drawer hole is recessed in a front end surface of the machine body, and the water tank is slidably arranged in the drawer hole.

In some embodiments of the present disclosure, the water drainage port is arranged at a front end of the water collecting plate and directly faces the water receiving port, the water collecting plate has a flow guide surface that is inclined downward from back to front, and the flow guide surface is configured to drain received liquid to the water drainage port.

In some embodiments of the present disclosure, the water collecting plate includes an elongated arc-shaped plate, the arc-shaped plate has a cross-section in an arc shape with an opening facing the material container, an inner surface of the arc-shaped plate is inclined downward from back to front to form the flow guide surface, and the water drainage port is located at a lowest point of the arc-shaped plate.

In some embodiments of the present disclosure, the ice making assembly extends along a front-back direction of the machine body, the material container has a switch mechanism that extends forward out of a front end of the machine body to output shaved ice, and the machine body is provided with a water receiving tray below the switch mechanism.

In some embodiments of the present disclosure, an overflow structure capable of being in communication with the water receiving tray is arranged inside the water tank.

In some embodiments of the present disclosure, the overflow structure includes an overflow pipe formed on an inner wall of the water tank, the overflow pipe is open at upper and lower ends thereof, the lower end of the overflow pipe passes through a bottom wall of the water tank to be in communication with the water receiving tray, and the upper end of the overflow pipe is lower than an upper end of an inner cavity of the water tank.

In some embodiments of the present disclosure, the water receiving tray includes a water storage box that is detachably inserted into a bottom of the front end of the machine body and a surface cover closing an opening of the water storage box, a plurality of through holes are arranged in the surface cover, and a flow guide slot opposite to the lower end of the overflow pipe is formed in a rear side of the water storage box.

In some embodiments of the present disclosure, the machine body is provided with a first sliding slot extending along an axial direction of the material container below the material container, the water collecting plate is slidably mounted in the first sliding slot, and a fall-limiting structure is arranged between the front end of the water collecting plate and the first sliding slot.

In some embodiments of the present disclosure, the machine body is provided with a second sliding slot on a periphery of the ice making assembly, the second sliding slot is located directly above the first sliding slot and in communication with the first sliding slot, and the material container is slidably mounted in the second sliding slot.

Additional aspects and advantages of the present disclosure will be given in part in the following description, and in part will become apparent from the following description, or will be learned through the practice of the present disclosure

### BRIEF DESCRIPTION OF DRAWINGS

The present disclosure is further described below in conjunction with the accompanying drawings and embodiments.

FIG. 1 is a schematic structural view of a slush machine capable of collecting condensed water according to an embodiment of the present disclosure;

FIG. 2 is an exploded view of the structure in FIG. 1;

FIG. 3 is a cross-sectional schematic view of the structure in FIG. 1; and

FIG. 4 is a schematic structural view of a water collecting plate and a water tank in FIG. 2.

### Reference numerals:

machine body 100; drawer hole 110; first sliding slot 120; second sliding slot 130; ice making assembly 200; material container 300; switch mechanism 310; water collecting plate 400; water drainage port 410; flow guide surface 420; water tank 500; water receiving port 510; water receiving tray 600; water storage box 610; flow guide slot 611; surface cover 620; through hole 621; overflow pipe 700; fall-limiting structure 800.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by the terms such as “upper”, “lower”, “front”, “rear”, “left”, “right”, “vertical”, “horizontal”, “top”, “bottom”, “inner”, “outer”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense. For example, they may be a fixed connection, or a detachable connection, or an integrated connection, may be a mechanical connection or an electric connection, may be a direct connection or an indirect connection through an intermediation, or may be an internal connection between two elements. Those of ordinary skill in the art can determine the specific meanings of the above words in the present disclosure in a rational way in combination with the specific contents of the technical solutions.

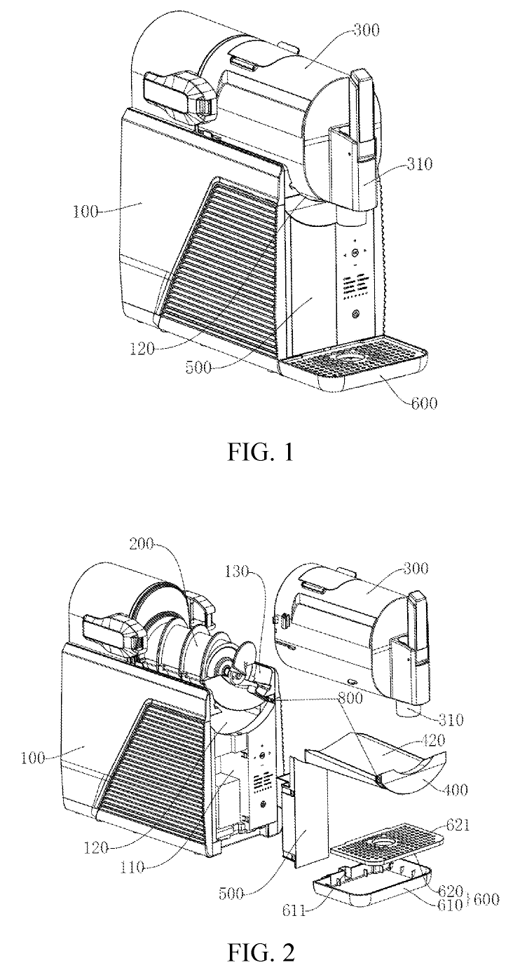

Referring to FIG. 1 to FIG. 3, a slush machine capable of collecting condensed water in the present disclosure, including a machine body 100. The machine body 100 is provided with a horizontally placed ice making assembly 200 and a material container 300 detachably sleeved over the ice making assembly 200. The machine body 100 is provided with a water collecting plate 400 below the material container 300, the machine body 100 is detachably provided with a water tank 500 below the water collecting plate 400, a water receiving port 510 facing the water collecting plate 400 is arranged at an upper end of the water tank 500, a water drainage port 410 aligned with the water receiving port 510 is arranged in the water collecting plate 400. When the material container 300 is separated from the ice making assembly 200, a height space is defined between the ice making assembly 200 and the water collecting plate 400, allowing for cleaning the water collecting plate 400.

In the slush machine of the above structure, the water collecting plate 400 is used to receive the condensed water dripping from the outer peripheral wall of the material container 300. The condensed water enters the water tank 500 through the water drainage port 410 and the water receiving port 510 in turn. The condensed water can be poured out by removing the water tank 500 from the machine body 100. When the shaved ice remains on the water collecting plate 400 due to removing the material container 300, the cleaning can also be achieved even if the shaved ice solution enters the water tank 500. The height space between the ice making assembly 200 and the water collecting plate 400 can enable users to clean the shaved ice remaining on the water collecting plate 400. In the above slush machine, it is unnecessary to connect the water receiving tray 600 with a water pipe. This avoids increasing the volume of the water receiving tray 600, and facilitates cleaning of the collected condensed water or shaved ice to avoid foreign matter residue.

Referring to FIG. 1 and FIG. 2, in some embodiments of the present disclosure, a drawer hole 110 is recessed in a front end surface of the machine body 100, and the water tank 500 is slidably arranged in the drawer hole 110. The water tank 500 is inserted along the drawer hole 110 to receive the liquid flowing downward from the water drainage port 410. When the liquid in the water tank 500 needs to be poured out or the inside of the water tank 500 needs to be cleaned, it only needs to pull out the water tank 500 from the drawer hole 110. The water tank 500 is located at the front end surface of the machine body 100, which makes the installation and disassembly of the water tank 500 more convenient and simple.

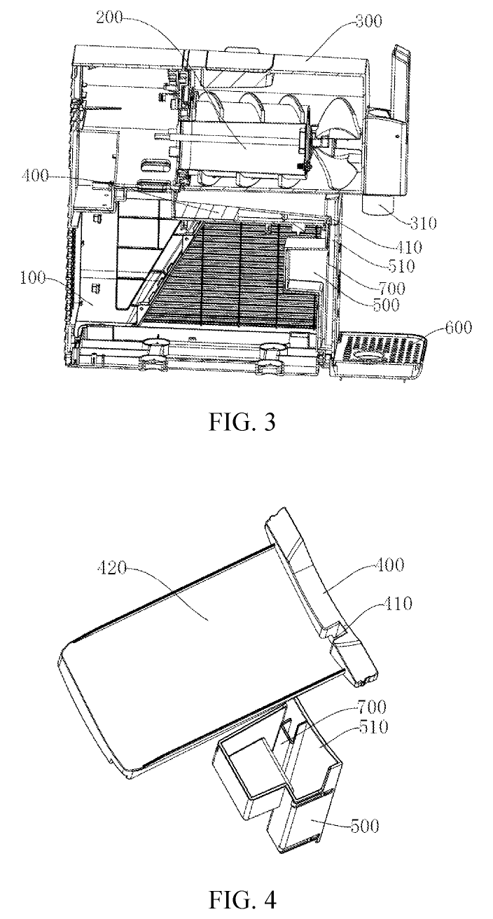

Referring to FIG. 3 and FIG. 4, in some embodiments of the present disclosure, the water drainage port 410 is arranged at a front end of the water collecting plate 400 and directly faces the water receiving port 510. The water collecting plate 400 has a flow guide surface 420 that is inclined downward from back to front, and the flow guide surface 420 can drain the received liquid to the water drainage port 410. It can be understood that the liquid dripping downward from the outer peripheral wall of the material container 300 falls on the water collecting plate 400 and flows along an inclined direction of the flow guide surface 420 to the water drainage port 410, which can effectively avoid the problem of bacterial growth caused by liquid residue and ensure that the liquid can flow into the water tank 500 through the water receiving port 510 in time.

Referring to FIG. 2 and FIG. 4, in some embodiments of the present disclosure, the water collecting plate 400 includes an elongated arc-shaped plate. The arc-shaped plate has a cross-section in an arc shape with an opening facing the material container 300, an inner surface of the arc-shaped plate is inclined downward from back to front to form the flow guide surface 420, and the water drainage port 410 is located at the lowest point of the arc-shaped plate. It should be noted that the water droplets dripping from the outer peripheral wall of the material container 300 onto the water collecting plate 400 may be located at various positions in a width direction of the water collecting plate 400. The arc-shaped plate helps to converge the water droplets on both sides to the middle position, and then direct the water droplets to the water drainage port 410 along the inclined direction of the flow guide surface 420, which can effectively prevent a large amount of water droplets from remaining on the water collecting plate 400.

Referring to FIG. 1 and FIG. 3, in some embodiments of the present disclosure, the ice making assembly 200 extends along a front-back direction of the machine body 100, the material container 300 has a switch mechanism 310 that extends forward out of the front end of the machine body 100 to output the shaved ice, and the machine body 100 is provided with a water receiving tray 600 below the switch mechanism 310. It can be understood that the water receiving tray 600 is used to place a shaved ice container to receive the shaved ice discharged from the switch mechanism 310. When the shaved ice container is moved away, a small amount of shaved ice in the switch mechanism 310 will melt and drip onto the water receiving tray 600, avoiding contaminating a desktop or other placement planes.

Referring to FIG. 3 and FIG. 4, in some embodiments of the present disclosure, an overflow structure capable of being in communication with the water receiving tray 600 is arranged inside the water tank 500. It is conceivable that when the water tank 500 is full of liquid and the user fails to promptly discover that the water tank 500 is full of liquid, the newly added liquid can be discharged into the water receiving tray 600 through the overflow structure, thus playing an emergency role.

Referring to FIG. 4, in some embodiments of the present disclosure, the overflow structure includes an overflow pipe 700 formed on an inner wall of the water tank 500, the overflow pipe 700 is open at upper and lower ends thereof. The lower end of the overflow pipe 700 passes through a bottom wall of the water tank 500 to be in communication with the water receiving tray 600, and the upper end of the overflow pipe 700 is lower than an upper end of an inner cavity of the water tank 500. It can be understood that when the height of the liquid in the water tank 500 exceeds the upper end of the overflow pipe 700, the liquid above the overflow pipe 700 can enter the overflow pipe 700, and then flow into the water receiving tray 600 from the lower end of the overflow pipe 700. The overflow structure is very simple and low in cost. Specifically, in this embodiment, the overflow pipe 700 and the water tank 500 are obtained by integral injection molding. Of course, in other embodiments, the overflow structure may also be an overflow hole formed in a side wall of the upper end of the water tank 500, and the overflow hole is in communication with the water receiving tray 600 through a hose.

Referring to FIG. 2, in some embodiments of the present disclosure, the water receiving tray 600 includes a water storage box 610 that is detachably inserted into a bottom of the front end of the machine body 100 and a surface cover 620 closing an opening of the water storage box 610. A plurality of through holes 621 are arranged in the surface cover 620, and a flow guide slot 611 opposite to the lower end of the overflow pipe 700 is formed in a rear side of the water storage box 610. It should be noted that the liquid discharged from the lower end of the overflow pipe 700 enters the water receiving tray 600 from the rear side of the water storage box 610, so that the overflow pipe 700 will not occupy the area of the water receiving tray 600 used to support the shaved ice container. The water receiving tray 600 of the above structure is also convenient for users to disassemble and clean.

Referring to FIG. 1 and FIG. 2, in some embodiments of the present disclosure, the machine body 100 is provided with a first sliding slot 120 extending along an axial direction of the material container 300 below the material container 300, the water collecting plate 400 is slidably mounted in the first sliding slot 120, and a fall-limiting structure 800 is arranged between the front end of the water collecting plate 400 and the first sliding slot 120. The water collecting plate 400 may move along the first sliding slot 120 to just below the material container 300 or leave the material container 300 along the first sliding slot 120, such that the water collecting plate 400 can be cleaned alone. The setting of the fall-limiting structure 800 prevents the water collecting plate 400 from falling off due to touching the water collecting plate 400 accidentally. In this embodiment, the fall-limiting structure 800 includes two elastic snap fasteners disposed on opposite sides of the first sliding slot 120, respectively. Correspondingly, the water collecting plate 400 has clamping slots matching with the elastic snap fasteners.

Referring to FIG. 1 and FIG. 2, in some embodiments of the present disclosure, the machine body 100 is provided with a second sliding slot 130 on a periphery of the ice making assembly 200, the second sliding slot 130 is located directly above the first sliding slot 120 and in communication with the first sliding slot 120, and the material container 300 is slidably mounted in the second sliding slot 130. The above structure also facilitates the disassembly and assembly of the material container 300, which saves effort and avoids scratching the ice making assembly 200.

Each technical feature of the above embodiments may be combined in any manner. For simplicity of description, not all possible combinations of each technical solution in the above embodiments are described. However, any combination of these technical features shall fall within the scope recorded in the specification without conflicting.

Although the embodiments of the present disclosure have been presented and described, those of ordinary skill in the art may understand that various changes, modifications, replacements and deformations can be made to these embodiments without deviating from the principles and gist of the present disclosure, and the scope of the present disclosure is defined by the appended claims and their equivalents.

What is claimed is:

1. A slush machine capable of collecting condensed water, comprising:
a machine body, wherein the machine body is provided with a horizontally placed ice making assembly and a material container detachably sleeved over the ice making assembly, the machine body is provided with a water collecting plate below the material container, the machine body is detachably provided with a water tank below the water collecting plate, a water receiving port facing the water collecting plate is arranged at an upper end of the water tank, a water drainage port aligned with the water receiving port is arranged in the water collecting plate, and when the material container is separated from the ice making assembly, a height space capable of cleaning the water collecting plate is defined between the ice making assembly and the water collecting plate.

2. The slush machine capable of collecting condensed water according to claim 1, wherein:
a drawer hole is recessed in a front end surface of the machine body, and the water tank is slidably arranged in the drawer hole.

3. The slush machine capable of collecting condensed water according to claim 2, wherein:
the water drainage port is arranged at a front end of the water collecting plate and directly faces the water receiving port, the water collecting plate has a flow guide surface that is inclined downward from back to front, and the flow guide surface is configured to drain received liquid to the water drainage port.

4. The slush machine capable of collecting condensed water according to claim 3, wherein:
the water collecting plate comprises an elongated arc-shaped plate, the arc-shaped plate has a cross-section in an arc shape with an opening facing the material container, an inner surface of the arc-shaped plate is inclined downward from back to front to form the flow guide surface, and the water drainage port is located at a lowest point of the arc-shaped plate.

5. The slush machine capable of collecting condensed water according to claim 1, wherein:
the ice making assembly extends along a front-back direction of the machine body, the material container has a switch mechanism that extends forward out of a front end of the machine body to output shaved ice, and the machine body is provided with a water receiving tray below the switch mechanism.

6. The slush machine capable of collecting condensed water according to claim 5, wherein
an overflow structure capable of being in communication with the water receiving tray is arranged inside the water tank.

7. The slush machine capable of collecting condensed water according to claim 6, wherein:
the overflow structure comprises an overflow pipe formed on an inner wall of the water tank, the overflow pipe is open at upper and lower ends of the overflow pipe, the lower end of the overflow pipe passes through a bottom wall of the water tank to be in communication with the water receiving tray, and the upper end of the overflow pipe is lower than an upper end of an inner cavity of the water tank.

8. The slush machine capable of collecting condensed water according to claim 7, wherein:
the water receiving tray comprises a water storage box that is detachably inserted into a bottom of the front end of the machine body and a surface cover closing an opening of the water storage box, a plurality of through holes are arranged in the surface cover, and a flow guide slot opposite to the lower end of the overflow pipe is formed in a rear side of the water storage box.

9. The slush machine capable of collecting condensed water according to claim 1, wherein:
the machine body is provided with a first sliding slot extending along an axial direction of the material container below the material container, the water collecting plate is slidably mounted in the first sliding slot, and a fall-limiting structure is arranged between a front end of the water collecting plate and the first sliding slot.

10. The slush machine capable of collecting condensed water according to claim 9, wherein:
the machine body is provided with a second sliding slot on a periphery of the ice making assembly, the second sliding slot is located directly above the first sliding slot and in communication with the first sliding slot, and the material container is slidably mounted in the second sliding slot.
